(19) United States
(12) Patent Application Publication
(10) Pub. No.: US 2008/0212817 A1
(43) Pub. Date: Sep. 4, 2008

(54) Hearing device with basic structure

(76) Inventors: Dietmar Lommel, Poxdorf (DE); Josef Ruppert, Kleinsendelbach (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/072,845

(22) Filed: Feb. 28, 2008

(30) Foreign Application Priority Data
Mar. 1, 2007 (DE) 102007010014.2

(51) Int. Cl. H04R 25/00

(52) U.S. Cl. 381/323; 381/324

(57) ABSTRACT

A frame is provided for the hearing device, which frame is constructed in such a way that it holds all of the internal components. The shells or the battery compartment are secured to the frame. Thereby, a conversion of a hearing device by the ordinary acoustician is possible.

### CROSS REFERENCE TO RELATED APPLICATIONS

This application claims priority of German application No. 102007010014.2 DE filed Mar. 1, 2007, which is incorporated by reference herein in its entirety.

### FIELD OF INVENTION

The present invention relates to a structure of a hearing device.

### BACKGROUND OF INVENTION

Because the electronic or, as the case may be, electromechanical components were held in the shells, the conversion is relatively time-consuming and can only be carried out by professionally trained personnel. A test of the functionality and/or stability (acoustics) was necessary in every case.

### SUMMARY OF INVENTION

The conversion of a hearing device by the ordinary acoustician was not possible in the prior art. Only a small number of company chains were able to perform this conversion.

According to the invention the frame is constructed in such a way that it holds all of the internal components. This basic frame structure, which, together with the internal components, is referred to as the basic structure or basic device, is color-neutral. The shells or, as the case may be, the battery compartment are secured to the frame, e.g. by means of pins.

In addition to the improved conversion capability of the hearing device, the neutral basic device also leads logistically to simplification, since shells or battery compartments can be combined with less frequently required colors only at the customer's request. Even the acoustician can put together different color combinations at the customer's request. A full functional test is thereupon no longer necessary.

### BRIEF DESCRIPTION OF THE DRAWINGS

An exemplary embodiment of the invention is explained in more detail below with reference to the drawing, which comprises three figures.

FIG. 1 shows the structure of an exemplary frame which consists of a basic frame GR (bottom frame) and a cover frame DR (top frame).

FIG. 2 shows an exemplary hearing device which comprises a frame FR, a top shell OS, a bottom shell US and a battery compartment BF.

FIG. 3 shows an orthogonal and/or right-angled separation of the frame relative to the shell.

### DETAILED DESCRIPTION OF INVENTION

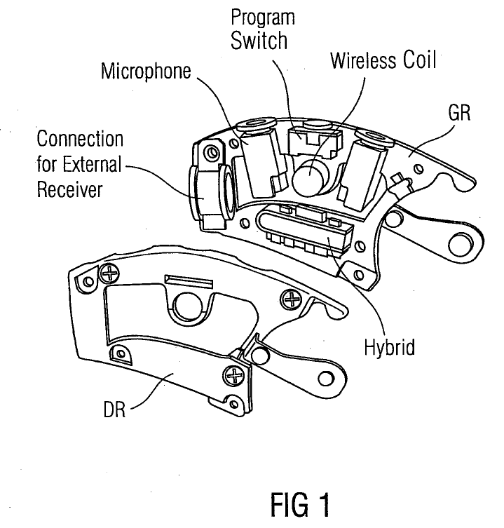

FIG. 1 shows the structure of an exemplary frame which consists of a basic frame GR (bottom frame) and a cover frame DR (top frame). The basic frame is embodied in such a way that it can hold all of the internal components (e.g. program switch, microphone, etc.).

The cover frame is embodied in such a way that it can be joined to the basic frame by means of pins, and after being joined forms, in combination with the basic frame, a stable frame over which the shells or the battery compartment are secured by means of pins.

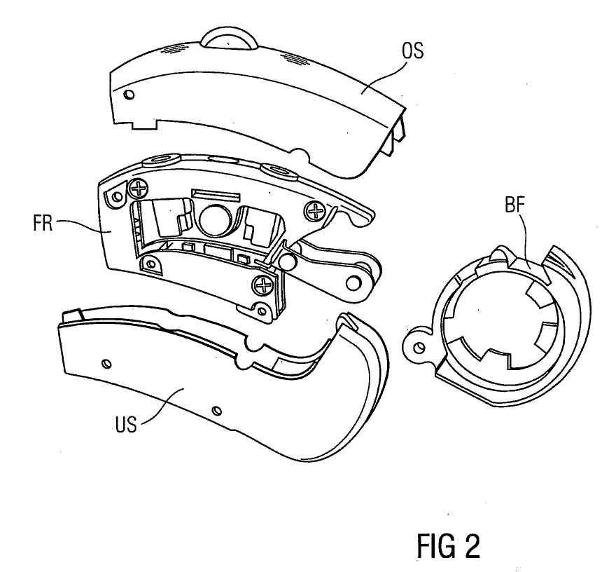

FIG. 2 shows an exemplary hearing device which comprises a frame FR, a top shell OS, a bottom shell US and a battery compartment BF. In the case of the illustrated frame FR the basic frame GR is already joined to the cover frame DR.

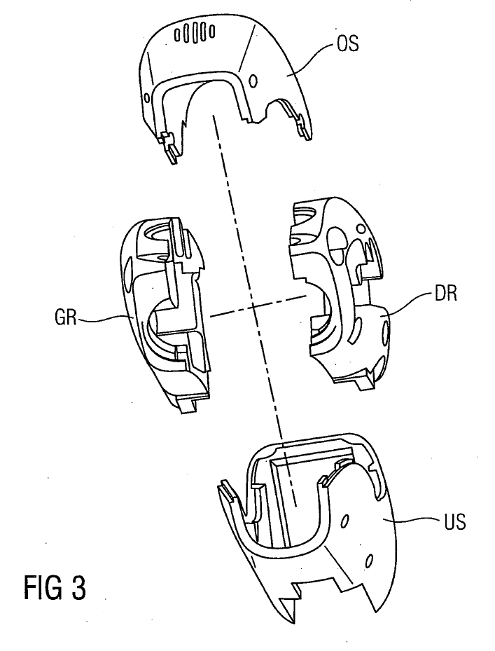

FIG. 3 shows an orthogonal and/or right-angled separation of the frame relative to the shell. The top or bottom shell is opened vertically, the basic or cover frame horizontally.

As a result of the cited separation, frame and housing mutually brace each other very well, thereby minimizing vibrations of the housing.

1.-3. (canceled)

4. A hearing device, comprising
a frame via which all internal components are held; and
a shell which is secured to the frame.

5. The hearing device as claimed in claim 4, wherein the shell and the battery compartment are secured to the frame via pins.

6. The hearing device as claimed in claim 4, wherein the frame is separated at right angles relative to the shell.

7. The hearing device as claimed in claim 5, wherein the shell and the battery compartment are secured to the frame via pins.

8. A hearing device, comprising
a frame via which all internal components are held; and
a shell which is secured to the frame,
wherein the frame is separated at right angles relative to the shell.

9. A hearing device, comprising
a frame via which all internal components are held; and
a shell which is secured to the frame,
wherein the shell and the battery compartment are secured to the frame via pins.
